(19) United States
(12) Patent Application Publication
(10) Pub. No.: US 2016/0254589 A1
(43) Pub. Date: Sep. 1, 2016

(54) NEAR FIELD COMMUNICATION ANTENNA AND SMARTPHONE HAVING SAME ANTENNA

(71) Applicant: AQ CORPORATION, Seoul (KR)

(72) Inventors: Seong Nam JU, Bucheon-si (KR); Won Kyu KIM, Gimpo-si (KR); Jae Won KIM, Boryeong-si (KR); Hong Soon KO, Seoul (KR)

(73) Assignee: AQ Corporation, Seoul (KR)

(21) Appl. No.: 14/905,941

(22) PCT Filed: Jul. 17, 2014
(86) PCT No.: PCT/KR2014/006480

§ 371 Date: Apr. 26, 2016

(30) Foreign Application Priority Data
Jul. 17, 2013 (KR) 10-2013-0084414
Nov. 5, 2013 (KR) 10-2013-0133627

(51) Int. Cl. H01Q 1/24; H04B 5/00; H01Q 7/06

(52) U.S. Cl. CPC H01Q 1/243; H01Q 7/06; H04B 5/0081

(57) ABSTRACT

Disclosed is a near field communication antenna comprising: a plate-shaped magnetic core; and an antenna coil having a wire wound multiple times in a loop shape, wherein the magnetic core comprises a first surface, a second surface facing opposite the first surface, and a side surface connecting the first and second surfaces. The antenna coil comprises a first portion placed over the first surface of the magnetic core, a second portion placed over the second surface of the magnetic core, and a connection portion placed over the side surface of the magnetic core to connect the first and second portions, and the first portion, the second portion, and the connection portion are joined to form a loop.

### TECHNICAL FIELD

The present disclosure relates to a near field communication antenna and a smartphone having the antenna.

### BACKGROUND ART

Near Field Communication (NFC) is a standard allowing wireless communication between portable devices such smartphones or between a portable device and a device (an NFC terminal) fixed on the ground or a building. For the communication, for example, a portable device having a near field communication device is brought into contact with or placed in the vicinity of the NFC terminal. Then, a near field communication channel is established between the portable device and the NFC terminal, so that the portable device may perform near field communication with the NFC terminal.

Recently, a circuit and an antenna for enabling near field communication begin to be mounted in a smartphone. However, many kinds of wireless communication devices are already embedded in the smartphone, and various kinds of antennas are also mounted in the smartphone. In addition, components that may affect the wireless communication, such as a battery and the like, are also mounted in the smartphone. Accordingly, there is a constraint of space in installing the NFC circuit or antenna. There are a lot of things to be considered in reality in order to satisfy conditions required by standards of the near filed communication even under the constraint of space.

The above description is intended to illustrate the general background of the present disclosure and does not constitute an admission that the described contents are prior art.

### DISCLOSURE OF INVENTION

### Technical Problem

Accordingly, the present disclosure provides a near field communication antenna and a smartphone having the antenna, wherein the antenna can exhibit sufficient antenna performance even when the antenna is small in size and, when formed into a fold type antenna to be installed in the smartphone, prevent cancellation between antenna pattern coils respectively positioned on top and bottom surfaces of the fold type antenna in a folded state.

Further, an aspect of the present disclosure provides a near field communication antenna and a smartphone having the antenna, wherein manufacturing costs can be reduced by simplifying the configuration of the antenna installed in a case made of an electrically conductive metal in a mobile communication terminal.

### Technical Solution

According to an aspect of the present disclosure, there is provided a smartphone including a housing, and a near field communication (NFC) antenna housed in the housing, wherein the housing includes a rear cover defining a backside of the smartphone, wherein the rear cover includes an electrically conductive first metal plate portion, an electrically conductive second metal plate portion spaced apart from the first metal plate portion, and an electrically non-conductive cover portion disposed between the first metal plate portion and the second metal plate portion, wherein the first metal plate portion has a first edge and the second metal plate portion includes a second edge facing the first edge, and the electrically non-conductive cover portion connects the first edge and the second edge, wherein the NFC antenna includes a plate-shaped magnetic core, and an antenna coil having a wire wound multiple times in a loop shape, wherein the magnetic core includes a first surface, a second surface facing opposite the first surface, and one side surface connecting the first surface and the second surface, and wherein the antenna coil includes a first portion placed over the first surface of the magnetic core, a second portion placed over the second surface of the magnetic core, and a connection portion placed over the side surface of the magnetic core and connecting the first portion and the second portion, wherein the first portion, the second portion, and the connection portion are joined to form a loop, wherein the NFC antenna is disposed in the vicinity of the non-metal cover portion such that the first surface of the magnetic core faces the rear cover, and wherein when viewed in a direction perpendicular to the backside of the smartphone, at least a part of the first portion of the antenna coil is configured to be disposed between the first edge and the second edge so that radio waves generated by the first portion of the antenna coil may pass through the electrically non-conductive cover portion between the first edge and the second edge.

### Advantageous Effect

The present disclosure is advantageous in that a rear cover of a housing of a mobile communication terminal made of an electrically conductive metal is not used as a radiator by installing an antenna, which is disposed in an opening formed in the rear cover, to have a gap between the antenna and the rear cover, thereby omitting a separate electrode sheet and thus reducing manufacturing costs.

In addition, the present disclosure is advantageous in that cancellation of energy does not occur as an antenna coil pattern is folded and placed over top and the bottom surfaces such that portions of the antenna coil pattern are spaced apart from each other, thereby minimizing the thickness and area of a magnetic body sheet and thus reducing manufacturing costs.

### BRIEF DESCRIPTION OF DRAWINGS

FIG. 1 is a perspective view of a smartphone according to an embodiment of the present disclosure, showing a front side of the smartphone;

FIG. 2 is a perspective view of the smartphone shown in FIG. 1, showing a backside of the smartphone;

FIG. 3 is a rear view of the smartphone shown in FIG. 1, showing the backside of the smartphone;

FIG. 4 is a sectional view of a rear cover and a near field communication antenna of the smartphone according to the embodiment of the present disclosure;

FIG. 5 is a rear view illustrating the rear cover and the near field communication antenna of the smartphone shown in FIG. 4, showing the antenna with an electrically non-conductive cover removed;

FIG. 6 is a perspective view of the near field communication antenna shown in FIG. 5;

FIG. 7 is a view illustrating a loop antenna sheet portion, which is a part of the near field communication antenna shown in FIG. 6, in an unfolded state;

FIG. 8 is a sectional view of a rear cover and a near field communication antenna of a smartphone according to another embodiment of the present disclosure;

FIG. 9 is a rear view illustrating the rear cover and the near field communication antenna of the smartphone shown in FIG. 8, showing the antenna with an electrically non-conductive cover removed;

FIG. 10 is a perspective view of the near field communication antenna shown in FIG. 8;

FIG. 11 is a view illustrating a loop antenna sheet portion, which is a part of the near field communication antenna shown in FIG. 10, in an unfolded state;

FIGS. 12 and 13 are rear views respectively showing smartphones according to other embodiments of the present disclosure;

FIG. 14 is a view showing an example of a current signal supplied to a wire of an antenna; and

FIGS. 15 and 16 are sectional views respectively showing part of rear covers and near field communication antennas of smartphones according to further embodiments of the present disclosure.

### EMBODIMENTS OF THE INVENTION

In addition to the configuration of the smartphone described above, the first portion may include a first longitudinal linear section extending along a longitudinal direction parallel to the side surface of the magnetic core, the first longitudinal linear section may include a plurality of lines extending along the longitudinal direction and arranged parallel to one another, and at least part of the first portion of the antenna coil may be disposed between the first edge and the second edge so that the lines of the first longitudinal linear section do not overlap with the first metal plate portion and the second metal plate portion when viewed in the direction perpendicular to the backside of the smartphone. In this smartphone, the first longitudinal linear section of the antenna coil may not overlap with the magnetic core when viewed in the direction perpendicular to the backside of the smartphone. In the smartphone, the second portion of the antenna coil may include a second longitudinal linear section extending along the longitudinal direction parallel to the side surface of the magnetic core, the second longitudinal linear section may include a plurality of lines extending along the longitudinal direction and arranged parallel to one another, and the second longitudinal linear section of the coil may be spaced apart from the first longitudinal linear section of the coil such that there is no overlapping part when viewed in the direction perpendicular to the backside of the smartphone.

In addition to the configuration of the smartphone described above, the magnetic core may have another side surface facing opposite the one side surface, and the other side surface may be disposed between the first longitudinal linear section and the second longitudinal linear section when viewed in the direction perpendicular to the backside of the smartphone. The first longitudinal linear section of the antenna coil may overlap with the magnetic core when viewed in the direction perpendicular to the backside of the smartphone. The second portion of the antenna coil may include a second longitudinal linear section extending along the longitudinal direction parallel to the side surface of the magnetic core, the second longitudinal linear section may include a plurality of lines extending along the longitudinal direction and arranged parallel to one another, and the first longitudinal linear section and the second longitudinal linear section of the coil may overlap with each other when viewed in the direction perpendicular to the backside of the smartphone.

In addition to the configuration of the smartphone described above, the second portion of the antenna coil may overlap with the magnetic core when viewed in the direction perpendicular to the backside of the smartphone. Moreover, the smartphone may further include an additional magnetic core placed over the second surface of the magnetic core, wherein the second portion of the antenna coil may be disposed between the magnetic core and the additional magnetic core. The side surface of the magnetic core may be generally parallel to the second edge of the second metal plate portion, and when viewed in the direction perpendicular to the backside of the smartphone, the side surface may be disposed between the first edge and the second edge and spaced apart by a distance from the second edge so that a portion of magnetic flux passing through the side surface of the magnetic core may pass between the first edge and the second edge. The distance may be 0.5 mm to 5 mm when viewed in the direction perpendicular to the backside of the smartphone. The distance may be 1.5 mm to 3 mm when viewed in the direction perpendicular to the backside of the smartphone.

In addition to the configuration of the smartphone described above, the magnetic core may include another side surface facing opposite the one side surface, the other side surface may be generally parallel to the first edge of the first metal plate portion, and when viewed in the direction perpendicular to the backside of the smartphone, the other side surface may be disposed between the first edge and the second edge and a distance of the other side surface spaced apart from the first edge may be smaller than a distance of the side surface spaced apart from the second edge. The first and second metal plate portions may be made of aluminum or an aluminum alloy. The electrically non-conductive cover may be made of a polymeric plastic material. The NFC antenna may be attached to the electrically non-conductive cover.

According to another aspect of the present disclosure, there is provided a method of performing near field communication with an NFC terminal device outside a smartphone provided with a near field communication (NFC) module by using the smartphone, wherein the method includes providing the aforementioned smartphone; and supplying an electrical current signal to the antenna coil to generate radio waves to be transmitted to the NFC terminal device, wherein a position where a magnetic field strength H generated by the supply of the electrical current signal has a maximum value among positions over the rear cover is between the first edge and the second edge.

According to a further aspect of the present disclosure, there is provided a near field communication (NFC) antenna for use in a smartphone, wherein the antenna includes a plate-shaped magnetic core, and an antenna coil having a wire wound multiple times in a loop shape, wherein the magnetic core includes a first surface, a second surface facing opposite the first surface, and one side surface connecting the first surface and the second surface, wherein the antenna coil includes a first portion placed over the first surface of the magnetic core, a second portion placed over the second surface of the magnetic core, and a connection portion placed over the side surface of the magnetic core and connecting the first portion and the second portion, wherein the first portion, the second portion, and the connection portion are joined to form a loop, and wherein a part of the first portion of the coil does not overlap with the magnetic core when viewed in a direction perpendicular to the first surface of the magnetic core.

In the antenna described above, the first portion may include a first longitudinal linear section extending along a longitudinal direction parallel to the side surface of the magnetic core, the first longitudinal linear section may include a plurality of lines extending along the longitudinal direction and arranged parallel to one another, and the first longitudinal linear section may not overlap with the magnetic core when viewed in the direction perpendicular to the first surface of the magnetic core. Moreover, the second portion of the antenna coil may include a second longitudinal linear section extending along the longitudinal direction parallel to the side surface of the magnetic core, the second longitudinal linear section may include a plurality of lines extending along the longitudinal direction and arranged parallel to one another, and the second longitudinal linear section of the coil may be spaced apart from the first longitudinal linear section such that there is no overlapping part when viewed in the direction perpendicular to the first surface of the magnetic core. Furthermore, the magnetic core may have another side surface facing opposite the one side surface, and the other side surface may be disposed between the first longitudinal linear section and the second longitudinal linear section when viewed in the direction perpendicular to the first surface of the magnetic core. The second portion of the antenna coil may overlap with the magnetic core when viewed in the direction perpendicular to the first surface of the magnetic core. The antenna may further include an additional magnetic core placed over the second surface of the magnetic core, wherein the second portion of the antenna coil may be disposed between the magnetic core and the additional magnetic core.

According to a still further aspect of the present disclosure, there is provided a smartphone including a housing; and a near field communication (NFC) antenna housed in the housing, wherein the housing includes a rear cover defining a backside of the smartphone, wherein the rear cover includes an electrically conductive first metal plate portion, an electrically conductive second metal plate portion spaced apart from the first metal plate portion, and an electrically non-conductive cover portion disposed between the first metal plate portion and the second metal plate portion, wherein the first metal plate portion includes a first edge and the second metal plate portion includes a second edge facing the first edge, and the electrically non-conductive cover portion connects the first edge and the second edge, wherein the NFC antenna includes a plate-shaped magnetic core, and an antenna coil having a wire wound multiple times in a loop shape, wherein the magnetic core includes a first surface, a second surface facing opposite the first surface, and one side surface connecting the first surface and the second surface, wherein the antenna coil includes a first portion placed over the first surface of the magnetic core, a second portion placed over the second surface of the magnetic core, and a connection portion placed over the side surface of the magnetic core and connecting the first portion and the second portion, wherein the first portion, the second portion, and the connection portion are joined to form a loop, and wherein the first portion includes a first longitudinal linear section extending along a longitudinal direction parallel to the side surface of the magnetic core, wherein the first longitudinal linear section includes a plurality of lines extending along the longitudinal direction and arranged parallel to one another, and at least part of the lines of the first longitudinal linear section do not overlap with the magnetic core when viewed in a direction perpendicular to the backside of the smartphone, wherein the NFC antenna is disposed such that the first surface of the magnetic core faces the rear cover, and wherein when viewed in the direction perpendicular to the backside of the smartphone, at least part of the lines of the first longitudinal linear section are disposed between the first edge and the second edge so that they do not overlap with the first metal plate portion or the second metal plate portion.

In the smartphone described above, the second portion of the antenna coil may include a second longitudinal linear section extending along the longitudinal direction parallel to the side surface of the magnetic core, the second longitudinal linear section may include a plurality of lines extending along the longitudinal direction and arranged parallel to one another, and the second longitudinal linear section of the coil may be spaced apart from the first longitudinal linear section such that there is no overlapping part when viewed in the direction perpendicular to the backside of the smartphone. The magnetic core may have another side surface facing opposite the one side surface, and the other side surface may be disposed between the first longitudinal linear section and the second longitudinal linear section when viewed in the direction perpendicular to the backside of the smartphone. The second portion of the antenna coil may include a second longitudinal linear section extending along the longitudinal direction parallel to the side surface of the magnetic core, the second longitudinal linear section may include a plurality of lines extending along the longitudinal direction and arranged parallel to one another, and three fourth or more of the lines of the second longitudinal linear section of the coil do not overlap with the lines of the first longitudinal linear section when viewed in the direction perpendicular to the backside of the smartphone.

Furthermore, in the smartphone described above, the second portion of the antenna coil may overlap with the magnetic core when viewed in the direction perpendicular to the backside of the smartphone. The smartphone may further include an additional magnetic core placed over the second surface of the magnetic core, wherein the second portion of the antenna coil may be disposed between the magnetic core and the additional magnetic core. The side surface of the magnetic core may be generally parallel to the second edge of the second metal plate portion, and the side surface may be spaced apart from the second edge to be disposed between the first edge and the second edge when viewed in the direction perpendicular to the backside of the smartphone. The magnetic core may include another side surface facing opposite the one side surface, the other side surface may be generally parallel to the first edge of the first metal plate portion, and when viewed in the direction perpendicular to the backside of the smartphone, the other side surface may be disposed between the first edge and the second edge and a distance of the other side surface spaced apart from the first edge may be larger than a distance of the side surface spaced apart from the second edge.

Hereinafter, embodiments of the present disclosure will be described in detail with reference to the accompanying drawings. Actual shapes are reflected on respective components shown in the figures to aid understanding of the embodiments by those skilled in the art. However, the present disclosure is not limited to the lengths, thicknesses, areas thereof, proportions between them, and the like represented herein.

Meanwhile, terms for indicating a direction or a relative position such as front, back, upper, lower, left, right and the like are used herein. The terms are to provide convenience in understanding the descriptions of the illustrated embodiments and they themselves do not limit the present disclosure. It will be understood by those skilled in the art that the terms for indicating a direction or a relative position may be used in a different manner.

Smart Phone Having Near Field Communication Device

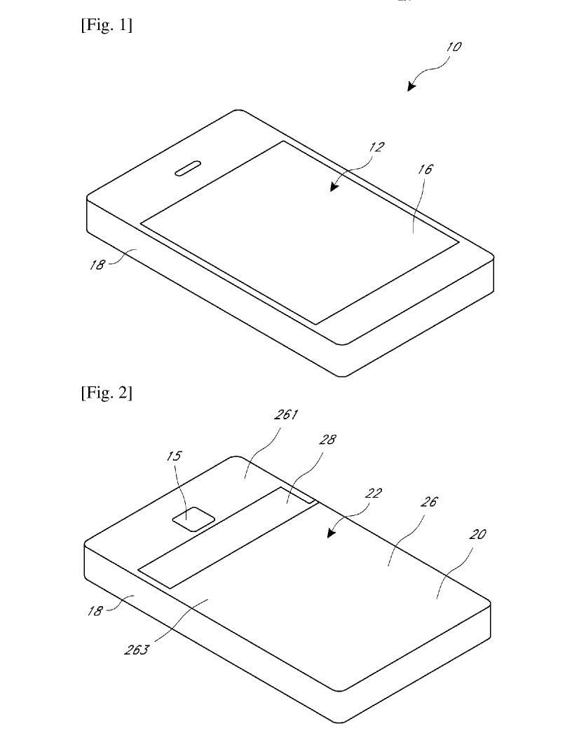

A smartphone according to an embodiment shown in FIGS. 1 to 3 has devices such as a display 12, various circuits (processor, memory, PCB and connecting wire), a battery 14, a camera 15, a plurality of wireless communication antennas 19 and 35 and the like. Referring to FIG. 1, the display 12 provided in the smartphone 10 has a display surface 16 exposed to the outside. Herein, a side on which the display surface 16 is provided is referred to as a front side. Another side opposite the display surface 16 is referred to as a backside. The smartphone 10 is provided with a housing 18 and various circuits, various modules such as a battery and the like, and a plurality of wireless communication antennas 19 and 35 are densely housed therein.

Near Field Communication Antenna

A near field communication antenna 35 is housed in the smartphone 10 for near field communication. However, since various kinds of components are densely populated in the smartphone as such, the configuration, position and orientation of the near field communication antenna and devices around the near field communication antenna greatly affect performance of the antenna.

Rear Cover

Referring to FIGS. 1 to 3, the housing 18 of the smartphone 10 includes a rear cover 22. The rear cover 22 provides a backside 20 of the smartphone. The rear cover 22 is provided with a hole through which a camera 15 is exposed.

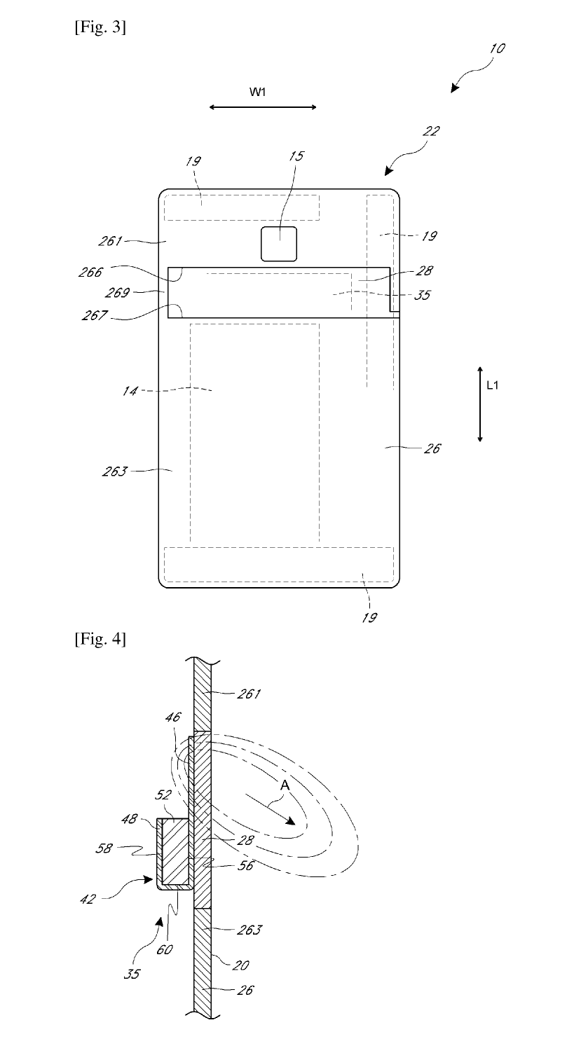

In the embodiment shown in FIGS. 2 and 3, the rear cover 22 is formed of a metal plate 26 provided with an opening. If most of the rear cover is formed of a metal plate, it is better resistant to pressure or impact exerted from the outside. Accordingly, the rear cover protects well the components housed in the smartphone 10. In addition, the metal plate has higher rigidity and strength compared with a plastic material, so that it may be made thinner. It is also advantageous in dissipating heat from the inside of the smartphone.

However, if all the rear cover is made of a metal plate, electromagnetic waves radiated from the near field communication antenna mounted within the housing can be blocked by the metal plate since the metal plate has electrical conductivity. Accordingly, as shown in FIGS. 2 to 5, an opening is formed in the metal plate 26, and the opening is covered with an electrically non-conductive non-metal cover 28 of a size corresponding to the opening, thereby forming the rear cover 22. The near field communication antenna is disposed at a position in the vicinity of the electrically non-conductive cover 28. In the illustrated embodiment, the metal plate 26 and the electrically non-conductive cover 28 are integrally connected to each other to form the rear cover 22. In order to enhance the strength of the rear cover 22, the metal plate 26 and the electrically non-conductive cover 28 can be formed integrally with sidewalls of the housing 18. Other openings of the metal plate are covered by equipment (for example, the camera 15) that needs the openings.

Material of Rear Cover

In the illustrated embodiment, the metal plate 26 has electrical conductivity and is made of a non-ferromagnetic metal. For example, the metal plate 26 may be made of aluminum or an aluminum alloy material. However, the present disclosure is not limited thereto. In other examples, the metal plate 26 may be made of copper, tin, titanium, a copper alloy, a tin alloy or a titanium alloy. Although such an electrically conductive metal material may be likely to hinder progress of radio waves due to generation of an eddy current, it does not greatly change a path of magnetic flux formed in the air since the electrically conductive metal material is a non-ferromagnetic material.

Meanwhile, the material of the electrically non-conductive cover 28 is substantially an electrically non-conductive material. In addition, the cover 28 can be made of a non-ferromagnetic material. For example, although the cover 28 can be made of a polymeric plastic material, the present disclosure is not limited thereto.

Arrangement of Antenna with Respect to Metal Plate

Since most of the rear cover 22 covering the near field communication antenna is formed of a metal plate 26 as described above, the metal plate 26 may affect propagation of the radio waves generated by the near field communication antenna. One of methods of minimizing such an effect is to prevent the antenna from being covered with the metal plate or to cause the antenna to be covered with the metal plate as little as possible. To this end, an opening is formed by removing a part of the metal plate 26 at a position where the antenna will be installed, and the opening can be covered with a non-metallic cover. However, if the opening is formed to be large, several advantages of the use of the metal plate can be diminished. Accordingly, in the illustrated embodiment, an antenna of a new configuration is proposed. In addition, the antenna is aligned with respect to the opening of the metal plate. In this manner, the effect of the metal plate on the radio waves radiated from the antenna is reduced or minimized even while using the metal plate. This will be described below.

Antenna of Near Field Communication Device

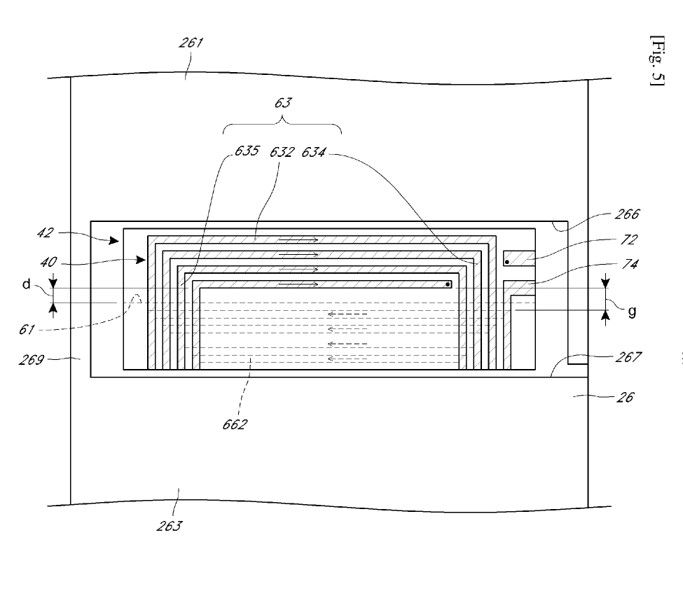

According to the embodiment of the present disclosure, as shown in FIGS. 4 to 7, a near field communication antenna 35 includes a magnetic core 52 and a loop antenna sheet 42 having a configuration folded over and covering the magnetic core 52. The loop antenna sheet 42 covers a first surface 56 (a surface facing the rear cover), a second surface 58 (a surface facing opposite the first surface 56) and a side surface 60 (a surface facing downward in FIG. 4) of the magnetic core.

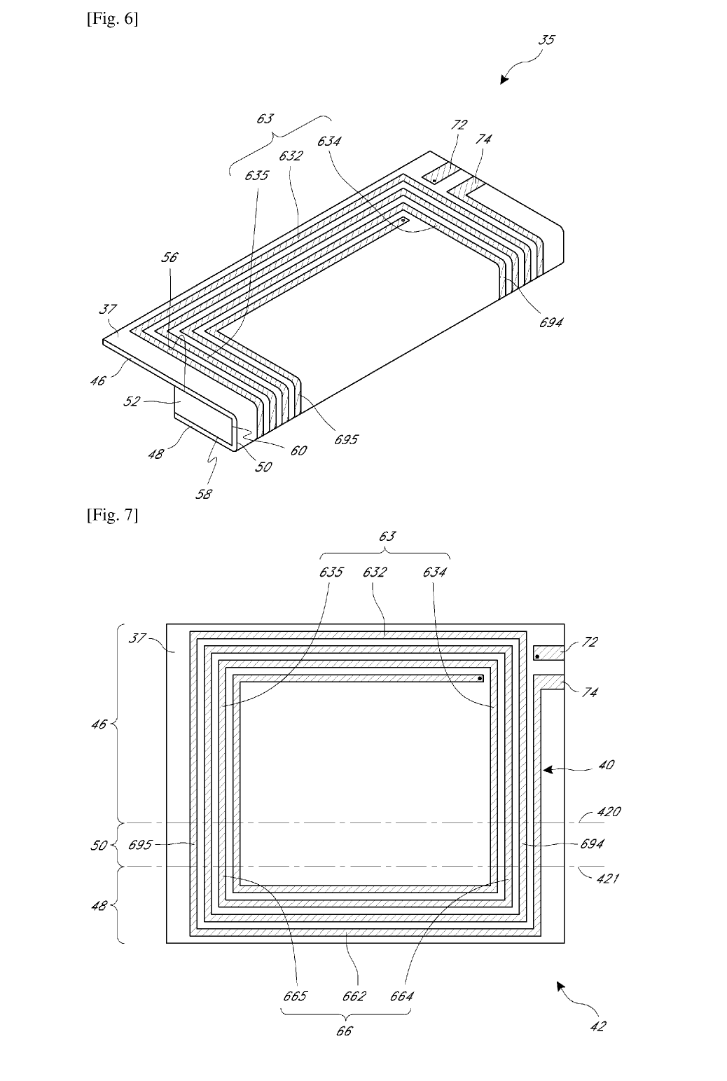

When the loop antenna sheet 42 is shown in an unfolded state for better understanding, the loop antenna sheet has a coil 40 wound multiple times in the shape of a loop over a substrate 37, as shown in FIG. 7. When the loop antenna sheet 42 is folded along imaginary folding lines 420 and 421, the loop antenna sheet 42 forms a first layer 46 and a second layer 48 as shown in FIG. 6, and a connection portion 50 makes connection between the first layer 46 and the second layer 48. The ferromagnetic core 52 is interposed between the first layer 46 and the second layer 48.

Coil

As seen from FIG. 7, the coil 40 forms a loop by winding one wire multiple times. Although it is shown in the figure that the coil is wound four times, the present disclosure is not limited thereto. A coil having three, four, five, six or more turns may be also used.

The coil 40 has a first portion 63 provided on the first layer 46 of the loop antenna sheet 42, a second portion 66 provided on the second layer 48, and a first connection portion 694 and a second connection portion 695 for connecting the first and second portions.

The first portion 63 has a first longitudinal linear section 632, and a first lateral linear section 634 and a second lateral linear section 635 connected to both sides of the first longitudinal linear section 632. Herein, the term “longitudinal” or “longitudinal direction” refers to a direction parallel to the side surface 60 of the magnetic core 52 (or an edge where the side surface 60 and the first surface 56 of the magnetic core 52 meet), and the term “lateral” or “lateral direction” refers to a direction perpendicular to the longitudinal direction. The second portion 66 has a second longitudinal linear section 662, and a third lateral linear section 664 and a fourth lateral linear section 665 connected to both sides of the second longitudinal linear section 662.

The first lateral linear section 634 is connected to the third lateral linear section 664 through the first connection portion 694, and the second lateral linear section 635 is connected to the fourth lateral linear section 665 through the second connection portion 695 so that an electrical current may flow therethrough.

In the illustrated embodiment, it is shown that each of the first longitudinal linear section 632, the first lateral linear section 634, the first connection portion 694, the third lateral linear section 664, the second longitudinal linear section 662, the fourth lateral linear section 665, the second connection portion 695 and the second lateral linear section 635 consists of four lines since the number of winding of the loop is four, although the present disclosure is not limited thereto.

In the illustrated embodiment, although the first longitudinal linear section 632 is longer than the first lateral linear section 634 and the second lateral linear section 635, the present disclosure is not limited thereto. Alternatively, the first longitudinal linear section 632 may be substantially equal to or shorter than the first lateral linear section 634 and the second lateral linear section 635 in length. In addition, although the second longitudinal linear section 662 is longer than the third lateral linear section 664 and the fourth lateral linear section 665, the present disclosure is not limited thereto. Alternatively, the second longitudinal linear section 662 may be substantially equal to or shorter than the third lateral linear section 664 and the fourth lateral linear section 665 in lengths.

In the illustrated embodiment, although the longitudinal lines (the first longitudinal linear section and the second longitudinal linear section) of the first and second portion 63 and 66 are expressed as lines generally parallel to the side surface 60 of the magnetic core 62, the present disclosure is not limited thereto. Alternatively, the longitudinal lines may be curved lines (e.g., curved lines having large radii of curvature). Furthermore, the longitudinal lines may not be completely parallel to the side surface 60 of the magnetic core 62.

Supply of Electrical Current

The ends of the coil are connected to supply pads 72 and 74 for connection to a near field communication device (NFC device) housed in the smartphone. The pads 72 and 74 may be disposed on the first layer 46. Although FIGS. 5 and 6 show that the pads 72 and 74 are on the right side, the pads may be disposed on the left or upper side according to the position of the near field communication module. Moreover, although FIGS. 5 and 6 show that the pads are disposed in the vicinity of the first longitudinal linear section 632, they may be disposed in the vicinity of the first connection portion 694, rather than the first longitudinal linear section 632.

The electrical current supplied through the supply pads 72 and 74 flows through the first lateral linear section 634, the first connection portion 694, the third lateral linear section 664, the second longitudinal linear section 662, the fourth lateral linear section 665, the second connection portion 695, the second lateral linear section 635 and the first longitudinal linear section 632 in this order.

FIG. 14 shows a waveform of the electrical current supplied to the antenna. As shown in the figure, the frequency of the current waveform conforms to standards of near field communication; maximum and minimum values of the magnitude of electrical current are values larger than zero; and the electrical current is supplied to consistently flow in a constant direction even though its magnitude is changed. However, the present disclosure is not limited thereto.

Although the electrical current flows in a direction designated by arrows in the embodiment shown in FIG. 5, the electrical current may flow in an opposite direction.

Shape and Material of Magnetic Core

Although the magnetic core 52 is in a rectangular plate shape having a thickness in the illustrated embodiment, the present disclosure is not limited thereto. A ferromagnetic material, e.g., a material such as ferrite, is used as the material of the magnetic core, but the present disclosure is not limited thereto. Alternatively, a ferromagnetic metal material such as steel may be used.

Relative Positions of Magnetic Core and First Longitudinal Linear Section

In the embodiment shown in FIGS. 4 to 6, when viewed in a direction perpendicular to the first surface 56 of the magnetic core 52, the first longitudinal linear section 632 is disposed not to overlap with the magnetic core. In the illustrated embodiment, the first longitudinal linear section 632 is spaced apart from the other side surface 61 (a side surface facing opposite the side surface 60) of the magnetic core by a distance d. The distance d may be about 0.1 mm to about 10 mm. In some embodiments, the distance d may be any one of about 0.05 mm, about 0.1 mm, about 0.15 mm, about 0.2 mm, about 0.25 mm, about 0.3 mm, about 0.4 mm, about 0.5 mm, about 0.6 mm, about 0.7 mm, about 1.0 mm, about 1.3 mm, about 1.5 mm, about 2.0 mm, about 3.0 mm, about 4.5 mm, about 6.0 mm, about 8.0 mm and about 10 mm. In other embodiments, the distance d may be a numerical value within a range between two numerical values selected from the aforementioned numerical values.

Generally, when the magnetic core does not exist in the vicinity, lines of magnetic flux draw generally circular around a wire though which an electrical current flows, and radio waves coming out from the wire radiate in all directions with a generally identical strength.

However, when the magnetic core exists in the vicinity, the lines of magnetic flix are distorted by the effect of the magnetic core, and a relatively intensive portion of the radio waves is generated according to the distortion. In the embodiment shown in FIG. 4, lines of magnetic flux may be formed as shown by one-dot chain lines, and accordingly, radio waves proceeding in a direction designated by an arrow A become radio waves having higher intensity than radio waves in other directions. Accordingly, the antenna may have directionality for causing radio waves to propagate in a desired direction.

Meanwhile, the lines of magnetic flux may be changed according to the thickness, length, permeability or the like of the magnetic core and modified into other forms by the relative positions (e.g., distance) or orientations of the first longitudinal linear section and the magnetic core. Accordingly, the propagation direction of the radio waves may be also changed.

In the embodiment shown in FIGS. 5 and 6, when viewed in the direction perpendicular to the first surface 56 of the magnetic core 52, the first longitudinal linear section 632 is disposed not to overlap with the magnetic core 52, but the present disclosure is not limited thereto. Part of the lines of the first longitudinal linear section 632 may be disposed to overlap with the magnetic core. For example, one line of the first longitudinal linear section 632 may at least partially overlap with the magnetic core. In another embodiment, a border of the line closest to the magnetic core among the several lines of the first longitudinal linear section 632 may be adapted to substantially coincide with the other side surface 61 of the magnetic core, when viewed in the direction perpendicular to the first surface of the magnetic core.

Relative Positions of Magnetic Core and Second Longitudinal Linear Section

Meanwhile, when viewed in the direction perpendicular to the first surface 56 of the magnetic core 52, the second longitudinal linear section 662 is disposed to overlap with the magnetic core. When an electrical current flows through the second longitudinal linear section 662 in a direction designated by arrows expressed with dotted lines, magnetic flux is generated. Since a considerable amount of the magnetic flux flows through the magnetic core 52 existing in close proximity thereto but the magnetic flux is not directed to the outside of the rear cover 22, it does not affect propagation of the radio waves used for near field communication.

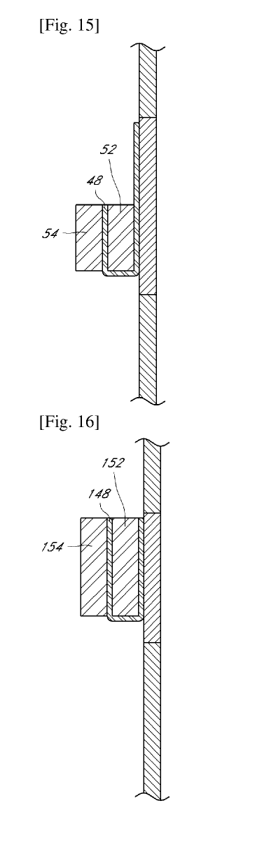

In order to further reduce the effect of the second longitudinal linear section 662, an additional plate-shaped magnetic body 54 may be further attached to one side of the second layer 48 as shown in FIG. 15. In this case, the second longitudinal linear section 662 is interposed between the magnetic core 52 and the additional magnetic body 54, and propagation of the radio waves from the second longitudinal linear section 662 toward the rear cover 22 is minimized. Accordingly, the radio waves coming out from the second longitudinal linear section 662 do not affect the radio waves coming out from the first longitudinal linear section 632.

In the embodiment shown in FIG. 5, although it is shown that all the lines of the second longitudinal linear section 662 are disposed to overlap with the magnetic core, the present disclosure is not limited thereto. At least part of the lines of the second longitudinal linear section 662 may not cover the magnetic core. For example, when viewed in the direction perpendicular to the first surface of the magnetic core, at least a part of one line of the second longitudinal linear section 662 may not overlap with the magnetic core. In another embodiment, a border of the line closest to the other side surface 61 of the magnetic core among the several lines of the second longitudinal linear section 662 may be adapted to substantially coincide with the other side surface 61 of the magnetic core, when viewed in the direction perpendicular to the first surface of the magnetic core.

Relative Positions of First Longitudinal Linear Section and Second Longitudinal Linear Section

In the illustrated embodiment, when viewed in the direction perpendicular to the first surface 56 of the magnetic core 52, the first longitudinal linear section 632 does not overlap with the second longitudinal linear section 662 and is spaced apart therefrom by a predetermined distance. The distance g may be about 0.3 mm to about 10 mm.

In some embodiments, the distance L may be any one of about 0.2 mm, about 0.25 mm, about 0.3 mm, about 0.4 mm, about 0.5 mm, about 0.6 mm, about 0.7 mm, about 1.0 mm, about 1.3 mm, about 1.5 mm, about 2.0 mm, about 3.0 mm, about 4.5 mm, about 6.0 mm, about 8.0 mm, about 10 mm, about 12 mm and about 15 mm. In other embodiments, the distance may be a numerical value within a range between two numerical values selected from the aforementioned numerical values.

When viewed in the direction perpendicular to the first surface 56 of the magnetic core 52, the distance g between the first longitudinal linear section 632 and the second longitudinal linear section 662 may affect performance of the antenna. Measurement results of a read range according to varying distances are shown in Table 1. In addition, Table 2 shows measurement results of load modulation values for different positions on a spatial coordinate.

TABLE 1

| | Tag 1 | Tag 2 | Tag 3 |
|---|---|---|---|
| g = 0 mm | 24 | 13 | 22 |
| g = 0.3 mm | 30 | 16 | 24 |
| g = 10 mm | 32 | 18 | 26 |

TABLE 2

| | Load modulation (mV) | | | |
|---|---|---|---|---|
| | Minimum value | | | |
| | required in | | | |
| POSITION | standards | g = 0 mm | g = 0.3 mm | g = 10 |
| 000 | 8.5 | 34.68 | 38.5 | 45.21 |
| 010 | 4.9 | 37.29 | 36.3 | 48.58 |
| 019 | | 21.28 | 30.4 | 40.46 |
| 100 | 7.2 | 17.46 | 22.7 | 28.05 |
| 110 | 4.1 | 16.12 | 17.3 | 24.37 |
| 119 | | 13.25 | 19.22 | 26.65 |
| 200 | 5.6 | 8.64 | 16.7 | 20.07 |
| 210 | 3.3 | 8.04 | 14.2 | 16.62 |
| 219 | | 4.6 | 12.1 | 18.83 |
| 300 | 4 | 2.29 | 11.2 | 14.37 |

In Table 1, Tag 1, Tag 2 and Tag 3 are standardized NFC tags for measuring a reader mode of a near field communication antenna. The read range increases as the distance g increases. In addition, the load modulation value also increases as the distance g increases. However, since the size of the antenna increases if the distance is too large, there may be limitation due to the constraint of space within the smartphone. Accordingly, the distance g may be within a range of the numerical values shown above.

In the embodiment shown in FIG. 5, when viewed in the direction perpendicular to the first surface of the magnetic core, it is shown that all the lines of the first longitudinal linear section 632 and all the lines of the second longitudinal linear section 662 are separated from each other, but the present disclosure is not limited thereto. For example, when viewed in the direction perpendicular to the first surface of the magnetic core, one line of the first longitudinal linear section 632 may at least partially overlap with another line of the second longitudinal linear section 662.

Relative Positions of Magnetic Core and Lateral Linear Section

In the illustrated embodiment, when viewed in the direction perpendicular to the first surface of the magnetic core, the third lateral linear section 664 (see FIG. 7) and the fourth lateral linear section 665 (see FIG. 7) completely overlap with the magnetic core 52. Furthermore, when viewed in the direction perpendicular to the first surface of the magnetic core, the outermost line of the first lateral linear section 634 and the second lateral linear section 635 overlap with the magnetic core. In another embodiment, part of the lateral linear sections 634, 635, 664 and 665 may be adapted not to overlap with the magnetic core by relatively reducing the size of the magnetic core. For example, at least part of the outermost line of the lateral linear sections 634, 635, 664 and 665 may be adapted not to overlap with the magnetic core. Meanwhile, all the lines of the lateral linear sections 634, 635, 664 and 665 may be adapted not to overlap with the magnetic core by reducing the size of the magnetic core.

Opening of Metal Plate

As shown in FIGS. 3 to 5, the metal plate 26 is divided into a first portion 261 and a second portion 263 by an opening. The first portion 261 has a first end (edge) 266, and the second portion 263 has a second end (edge) 267. The first end 266 and the second end 267 are positioned to face each other. In the embodiment shown in FIGS. 3 to 5, although the first portion 261 and the second portion 263 are connected to each other by the connection portion 269 on the left side and not connected on the right side, alternatively, the same kind of connection portion may be also provided on the right side.

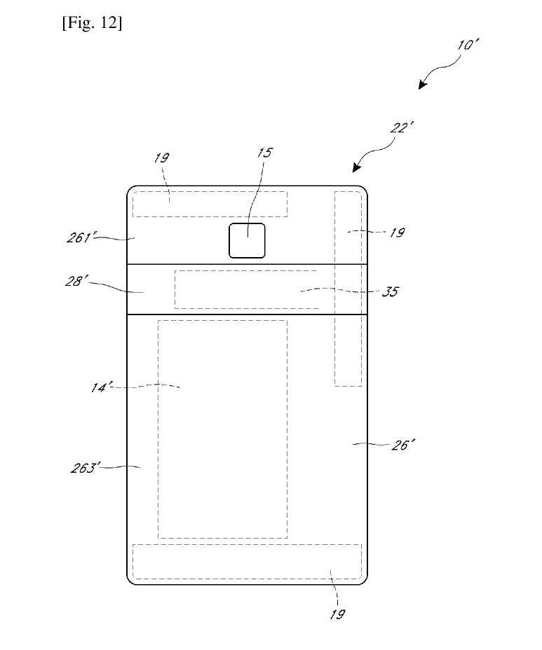

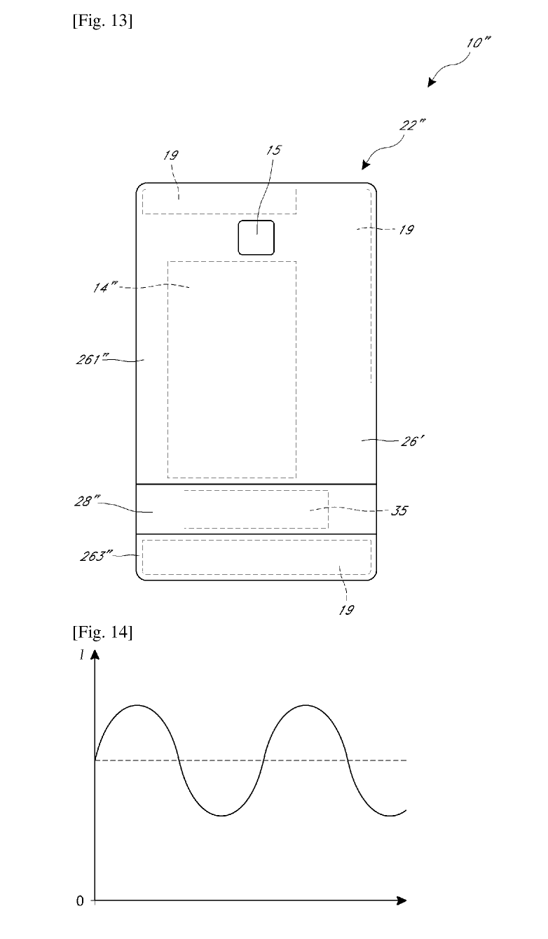

Furthermore, as shown in FIGS. 12 and 13, the first portion 261′ or 261″ and the second portion 263′ or 263″ may be configured to be completely separate from each other. It is apparent that the metal plate configuration of the rear cover shown in FIGS. 3 to 5 and the modifications shown in FIGS. 12 and 13 may be respectively applied to all other embodiments described herein.

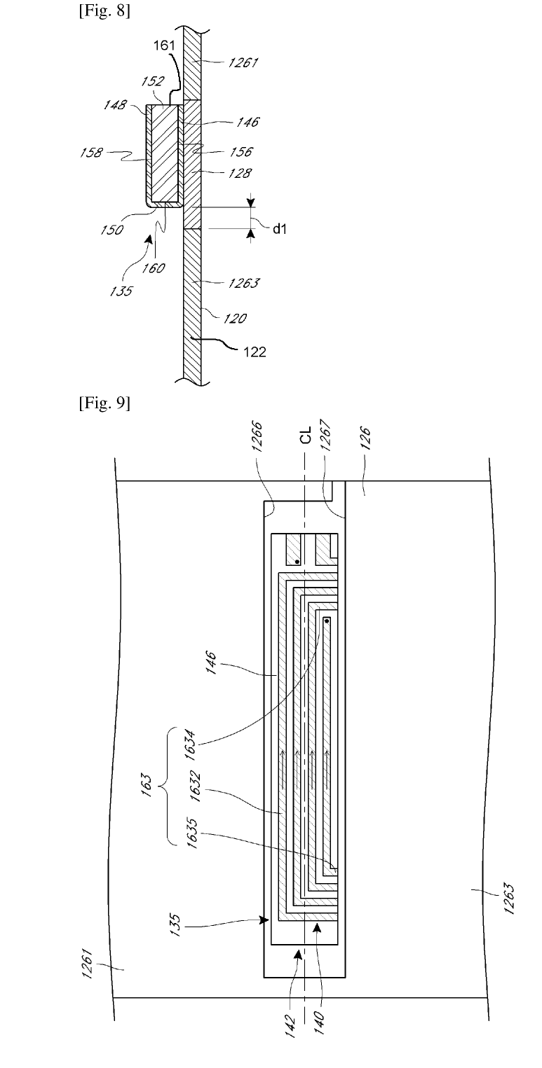

As described above, the opening of the metal plate is covered with the electrically non-conductive cover. In the embodiment shown in FIGS. 4 and 8, the first layer of the NFC antenna is attached to the electrically non-conductive cover using an adhesive or the like.

Relative Positions of Opening of Metal Plate and Antenna

As described above, in the embodiment shown in FIGS. 4 and 5, the antenna 35 has directionality, and radio waves of high intensity propagate in the direction designated by the arrow A. Accordingly, if a part of the antenna from which radio waves of high intensity are radiated is disposed between the two ends 266 and 267 of the metal plate (i.e., in the opening of the metal plate, which is a part covered with the electrically non-conductive cover 28), the effect of the metal plate 26 on the radiation of the radio waves of the antenna is reduced or minimized.

Accordingly, in the embodiment shown in FIGS. 3 and 5, when viewed in a direction perpendicular to the backside 20 of the rear cover 22, the near field communication antenna 35 is disposed between the first end 266 and the second end 267 so that it does not overlap with the first portion 261 and the second portion 263 of the metal plate 26. Particularly, the first longitudinal linear section 632 is disposed between the first end 266 and the second end 267 so that there is no part overlapping with the first portion 261 and the second portion 263 of the metal plate 261.

In the illustrated embodiment, a zone of intensive radio waves among the radio waves radiated from the first longitudinal linear section 632 is adapted to pass between the first end 266 and the second end 267 (i.e., the opening of the metal plate). Accordingly, if this condition is satisfied, it is also possible to implement an example in which the relative positions of the opening of the metal plate and the antenna are changed in different manners. For example, in FIG. 5, the second end 267 of the second portion 263 of the metal plate may be moved upwards in the figure and the second portion 263 may be extended to cover a part or all of the magnetic core 52. In this case, when viewed in the direction perpendicular to the first surface 56 of the magnetic core 52, the first connection portion 694 and the second connection portion 695 may overlap with the second portion 263 of the metal plate 26. In another embodiment, the second longitudinal linear section 662 may be partially or fully covered with the second portion 263 of the metal plate. In a further embodiment, the lateral linear sections 634, 635, 664 and 665 may be also partially or fully covered with the metal plate.

Moreover, FIG. 5 shows that all the lines of the first longitudinal linear section 632 are disposed within the opening and thus not covered with the first portion 261 of the metal plate. However, if most of the lines are not covered, part of the lines (e.g., one line) may be configured to be covered with the first portion 261 of the metal plate, when viewed in the direction perpendicular to the backside of the rear cover. For example, one fourth or less of the lines of the first longitudinal linear section 632 may be covered with the first portion 261, and in another embodiment, a half or less of the lines of the first longitudinal linear section 632 may be covered with the first portion 261. Meanwhile, in other embodiments, an outer border of an outermost line of the first longitudinal linear section 632 may be adapted to substantially coincide with the first edge 266, when viewed in the direction perpendicular to the backside of the rear cover.

In the embodiment shown in FIG. 5, the entire lengths of the lines of the first longitudinal linear section 632 are not covered with the metal plate, but the present disclosure is not limited thereto. In another embodiment, part thereof connected to the lateral linear sections may be covered with the metal plate.

In the embodiment shown in FIG. 5, it is shown that all the lines of the first longitudinal linear section 632 are disposed to be close to the first edge 266 rather than the second edge 267, but the present disclosure is not limited thereto. Alternatively, part of inner lines (e.g., one line) of the first longitudinal linear section 632 may be disposed in the middle between the two edges 266 and 267 or may be positioned to be close to the second edge 267 rather than the first edge 266.

Relative Positions of Antenna and Other Components of Smartphone

As shown in FIG. 3, the near field communication antenna (including the near field communication antennas according to all the embodiments described above and the near field communication antennas according embodiments to be described below) does not overlap with a battery and other antennas 19, when viewed in the direction perpendicular to the backside of the rear cover. When viewed in the direction perpendicular to the backside of the rear cover, all the first longitudinal linear sections 632 and 1632 do not overlap with a battery in an embodiment, and all the first longitudinal linear sections 632 and 1632 do not overlap with other antennas in another embodiment.

In the embodiment shown in FIG. 3, the near field communication antenna is disposed between the battery and the camera, when viewed in the direction perpendicular to the backside of the rear cover. In another embodiment shown in FIG. 13, the near field communication antenna is disposed between the battery and another antenna, when viewed in the direction perpendicular to the backside of the rear cover.

Manufacture of Antenna

First, as shown in FIG. 7, a coil 40 is formed to configure a loop on a substrate 37 of a deformable insulation material. A method of forming the coil may be any one of a coil embedding method, a coil winding method, an electroplating method, a sputtering method, an electrically conductive ink printing method and a stamping method. After the formation of the coil, an insulation layer is formed thereon.

The planar loop antenna sheet 42 formed thus is folded along the folding lines 420 and 421 and the magnetic core 52 is inserted into and attached to the folded sheet to complete the near field communication antenna 35, as shown in FIG. 6. However, the present disclosure is not limited thereto but may employ other manufacturing methods.

### Another Embodiment

Referring to FIGS. 8 to 10, a smartphone according to another embodiment has a different type of near field communication antenna 135. Other matters of the smartphone except for a different configuration of the antenna 136 and different relative positions of the antenna and other components of the smartphone may be configured in the same manner as those of the other embodiments described herein. Therefore, the antenna 135 used in this embodiment can be also applied to the other embodiments herein.

Arrangement of Antenna with Respect to Metal Plate

As in the embodiment shown in FIGS. 3 to 5, the effect of a metal plate 126 on the radio waves radiated from the antenna is reduced or minimized by arranging the antenna at a specific position with respect to the opening while reducing the size of the opening of the metal plate 126, even in the embodiment shown in FIGS. 8 to 10. This will be described below.

Near Field Communication Antenna

According to the embodiment shown in FIGS. 8 to 10, the near field communication antenna 135 includes a magnetic core 152 and a loop antenna sheet 142 having a configuration folded over and covering the magnetic core 152. The loop antenna sheet 142 covers a first surface 156, a second surface 158 and one side surface 160.

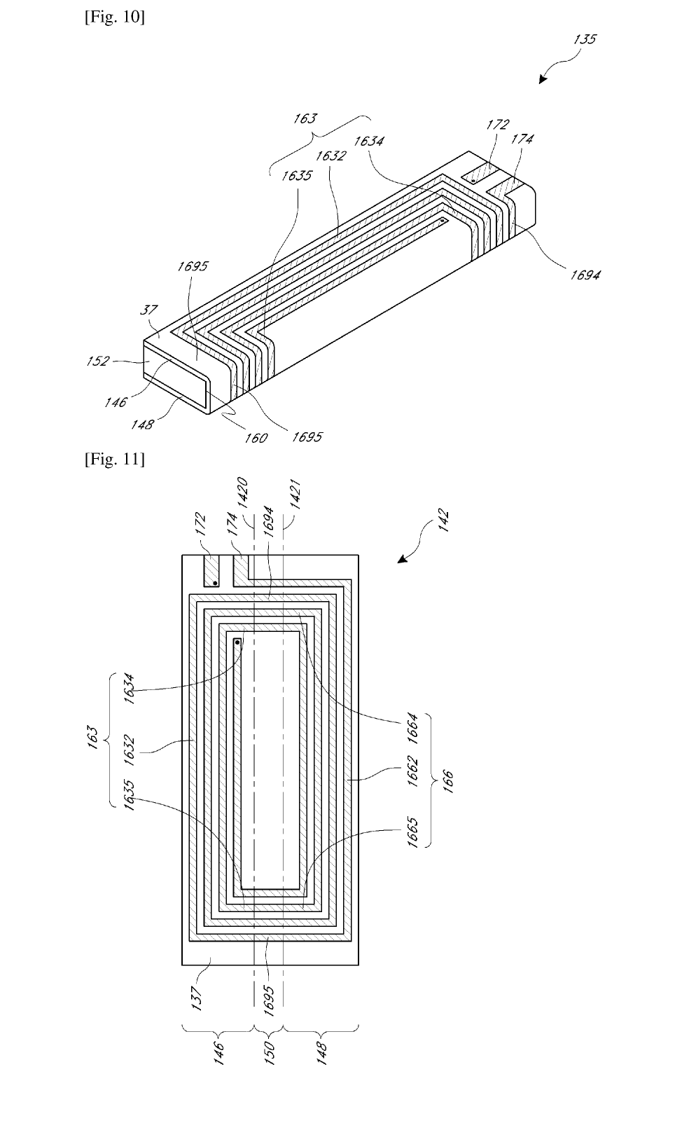

When the loop antenna sheet 142 is shown in an unfolded state for better understanding, the loop antenna sheet has a coil 140 (see FIG. 9) wound multiple times in the shape of a loop on a substrate 137, as shown in FIG. 11. When the loop antenna sheet 142 is folded along imaginary folding lines 1420 and 1421, the loop antenna sheet 142 forms a first layer 146 and a second layer 148 as shown in FIGS. 8 to 10, and a connection portion 150 makes connection between the first layer 146 and the second layer 148. The ferromagnetic core 52 is interposed between the first layer 46 and the second layer 48 and attached to the folded loop antenna sheet 142.

Coil

As seen from FIG. 11, the coil 140 forms a loop by winding one wire multiple times. The coil 140 has a first portion 163 provided on the first layer 146 of the loop antenna sheet 142, a second portion 166 provided on the second layer 148, and a connection portion for connecting the first and second portions.

The first portion 163 has a first longitudinal linear section 1632, and a first lateral linear section 1634 and a second lateral linear section 1635 connected to both sides of the first longitudinal linear section 1632. The second portion 166 has a second longitudinal linear section 1662, and a third lateral linear section 1664 and a fourth lateral linear section 1665 connected to both sides of the second longitudinal linear section 1662.

The first lateral linear section 1634 is connected to the third lateral linear section 1664 through the first connection portion 1694, and the second lateral linear section 1635 is connected to the fourth lateral linear section 1665 through the second connection portion 1695 so that an electrical current may flow therethrough.

In the illustrated embodiment, it is shown that each of the first longitudinal linear section 1632, the first lateral linear section 1634, the first connection portion 1694, the third lateral linear section 1664, the second longitudinal linear section 1662, the fourth lateral linear section 1665, the second connection portion 1695 and the second lateral linear section 1635 consists of four lines since the number of winding of the loop is four, although the present disclosure is not limited thereto.

In the illustrated embodiment, although the first longitudinal linear section 1632 is longer than the first lateral linear section 1634 and the second lateral linear section 1635, the present disclosure is not limited thereto. Alternatively, the first longitudinal linear section 1632 may be substantially equal to or shorter than the first lateral linear section 1634 and the second lateral linear section 1635 in length. In addition, although the second longitudinal linear section 1662 is longer than the third lateral linear section 1664 and the fourth lateral linear section 1665, the present disclosure is not limited thereto. Alternatively, the second longitudinal linear section 1662 may be substantially equal to or shorter than the third lateral linear section 1664 and the fourth lateral linear section 1665 in length.

In the illustrated embodiment, although the longitudinal lines (the first longitudinal linear section and the second longitudinal linear section) of the first and second portion 163 and 166 are expressed as lines generally parallel to the side surface 160 of the magnetic core 162, the present disclosure is not limited thereto. Alternatively, the longitudinal lines may be curved lines (e.g., curved lines having large radii of curvature). Furthermore, the longitudinal lines may not be completely parallel to the side surface 160 of the magnetic core 162.

Supply of Electrical Current

Even in the embodiment shown in FIGS. 8 to 11, the ends of the coil are connected to supply pads 172 and 174 for connection to a near field communication device (NFC device) housed in the smartphone, as in the embodiment described above, so that an electrical current may be supplied through the pads. As shown in FIG. 9, the electrical current supplied through the supply pads flows through the first lateral linear section 1634, the first connection portion 1694, the third lateral linear section 1664, the second longitudinal linear section 1662, the fourth lateral linear section 1665, the second connection portion 1695, the second lateral linear section 1635 and the first longitudinal linear section 1632 in this order. The electrical current used herein may be an electrical current having an electrical current waveform shown in FIG. 14.

Relative Positions of Magnetic Core and Longitudinal Linear Sections

As shown in FIGS. 8 to 10, when viewed in the direction perpendicular to the first surface 156 of the magnetic core 152, the first longitudinal linear section 1632 and the second longitudinal linear section 1662 completely overlap with the magnetic core. In addition, when viewed in the direction perpendicular to the first surface 156 of the magnetic core 152, the first longitudinal linear section 1632 and the second longitudinal linear section 1662 may be arranged to completely overlap with each other. Alternatively, when viewed in the direction perpendicular to the first surface 156 of the magnetic core 152, the first longitudinal linear section 1632 and the second longitudinal linear section 1662 may only partially overlap with each other. In another embodiment, when viewed in the direction perpendicular to the first surface 156 of the magnetic core 152, the lines of the second longitudinal linear section 1662 may be adapted to be disposed between the lines of the first longitudinal linear section 1632.

In the configuration shown in FIG. 10, due to the effect of the magnetic core 152, a considerable amount of magnetic flux may proceed through the side surface 160 and a part of the first surface 56 (particularly, a part close to the side surface 160) of the magnetic core when the electrical current flows through the first longitudinal linear section 1632. In response thereto, the direction of the most intensive radio waves generated by the first longitudinal linear section 1632 is biased to a direction in which much of the magnetic flux flows, so that the antenna has directionality.

Meanwhile, the lines of magnetic flux may be changed according to the thickness, length, permeability or the like of the magnetic core and modified into other forms by the relative positions (e.g., distance) or orientations of the first longitudinal linear section and the magnetic core. Accordingly, the propagation direction of the radio waves may be also changed.

In the embodiment shown in FIG. 9, when viewed in the direction perpendicular to the first surface 156 of the magnetic core 152, the first longitudinal linear section 1632 is disposed to completely overlap with the magnetic core 152. In the illustrated embodiment, when viewed in the direction perpendicular to the first surface of the magnetic core, an outer border of an outermost line of the first longitudinal linear section 1632 does not overlap with the other side surface 161 of the magnetic core. In another embodiment, when viewed in the direction perpendicular to the first surface of the magnetic core, the outer border of the outermost line of the first longitudinal linear section 1632 may be adapted to substantially coincide with the other side surface 161 of the magnetic core. However, the present disclosure is not limited thereto. Part or all of the lines of the first longitudinal linear section 1632 may be disposed not to overlap with the magnetic core by reducing the size of the magnetic core or moving the first longitudinal linear section 1632.

Furthermore, in an embodiment of the present disclosure, when viewed in the direction perpendicular to the first surface 156 of the magnetic core 152, the lines of the first longitudinal linear section 1662 are disposed to be substantially symmetrical with respect to a center line CL of the magnetic core 152 (a center line parallel to the side surface 160). However, the present disclosure is not limited thereto, and more lines may be disposed on any one side with respect to the center line CL than the other side. For example, one line may be disposed on one side closer to the side surface 160 based on the center line CL, and the other lines may be disposed on the other side. In one example, one third or less of the lines may be disposed on a side closer to the side surface 160 based on the center line CL, and two third or more of the lines may be disposed on a side far from the side surface 160. In another embodiment, one fourth or less of the lines may be disposed on a side closer to the side surface 160 based on the center line CL, and three fourth or more of the lines may be disposed on a side far from the side surface 160. In a further embodiment, two third or more of the lines may be disposed on a side closer to the side surface 160 and one third or less of the lines may be disposed on a side far from the side surface 160.

Meanwhile, when viewed in the direction perpendicular to the first surface 156 of the magnetic core 152, the second longitudinal linear section 1662 overlaps with the magnetic core, so that most of the magnetic flux generated by the second longitudinal linear section 1662 flows through the magnetic core 152 and is not directed toward the outside of a rear cover 122. Thus, the effect of the metal plate 126 of the rear cover 122 is minimized or almost does not exist such that the radio waves for wireless communication may be radiated to enable communication.

In order to further reduce the effect of the second longitudinal linear section 1662, an additional magnetic body plate may be further attached to one side of the second layer as shown in FIG. 16. In this case, the second longitudinal linear section 1662 is interposed between the magnetic core 152 and the additional magnetic body plate, and propagation of the radio waves from the second longitudinal linear section 1662 to the outside of the rear cover is minimized.

Relative Positions of Magnetic Core and Lateral Linear Sections

In the illustrated embodiment, when viewed in the direction perpendicular to the first surface of the magnetic core, the lateral linear sections 1634, 1635, 1664 and 1665 completely overlap with the magnetic core 152. In another embodiment, part of the lateral linear sections 1634, 1635, 1664 and 1665 may be adapted not to overlap with the magnetic core by relatively reducing the size of the magnetic core. For example, at least part of the outermost line of the lateral linear sections 1634, 1635, 1664 and 1665 may be adapted not to overlap with the magnetic core. Meanwhile, all the lines of the lateral linear sections 1634, 1635, 1664 and 1665 may be adapted not to overlap with the magnetic core by reducing the size of the magnetic core. Moreover, in a further embodiment, both side ends of the magnetic core may be adapted to substantially coincide with the outer border of the outermost line of the lateral linear sections 1634, 1635, 1664 and 1665.

Relative Positions of Opening of Metal Plate and Antenna

In the embodiment shown in FIGS. 8 and 9, when viewed in a direction perpendicular to a backside 120 of the rear cover 122, the near field communication antenna 135 is disposed between a first end 1266 and a second end 1267 so that it does not overlap with the metal plate 126. Particularly, the magnetic core 152 and the first longitudinal linear section 1632 are disposed between the first end 1266 and the second end 1267 so that they do not overlap with a first portion 1261 and a second portion 1263 of the metal plate 126.

Furthermore, when viewed in the direction perpendicular to the backside 120 of the rear cover 122, the side surface 160 of the magnetic core 152 is spaced apart from the second end 1267, i.e., spaced apart therefrom by a distance sufficient to minimize the effect of the metal plate 126 as described below. However, an increase in the distance may be limited due to the constraint of space in the smartphone. For example, the distance dl is about 0.5 mm to about 10 mm. In some embodiments, the distance dl may be any one of about 0.1 mm, about 0.15 mm, about 0.2 mm, about 0.25 mm, about 0.3 mm, about 0.4 mm, about 0.5 mm, about 0.6 mm, about 0.7 mm, about 1.0 mm, about 1.3 mm, about 1.5 mm, about 2.0 mm, about 3.0 mm, about 4.5 mm, about 6.0 mm, about 8.0 mm, about 10 mm, about 12 mm and about 15 mm. In another embodiment, the distance may be a numerical value within a range between two numerical values selected from the aforementioned numerical values

As described above, due to the effect of the magnetic core 152 shown in FIG. 10, the magnetic flux may proceed through the side surface 160 and a part of the first surface (a part in the vicinity of the side surface 160) of the magnetic core when an electrical current flows through the first longitudinal linear section 1632. Accordingly, when the side surface 160 of the magnetic core 152 is disposed too close to the second end 1267 or the side surface 160 of the magnetic core 152 is covered with the second portion 1263 of the metal plate 126, a considerable amount of magnetic flux passes through the metal plate 126. If there is a change in the magnetic flux, an eddy current may be generated in the metal plate 126, and this may have a negative effect on the propagation of the radio waves.

Accordingly, in the illustrated embodiment, when viewed in the direction perpendicular to the backside 120 of the rear cover 122, the side surface 160 of the magnetic core 152 is spaced apart from the second end 1267. The distance dl may be a distance within a range of the numerical values described above. In such a configuration, a considerable amount of the magnetic flux may proceed through the opening, i.e., a part uncovered with the metal plate (i.e., a part covered with an electrically non-conductive cover 128), thereby reducing or minimizing the effect of the metal plate 128.

In the embodiment shown in FIG. 9, although all the lines of the first longitudinal linear section 1632 are disposed between the first end 1266 and the second end 1267 (i.e., the opening of the metal plate), part or all of the lines of the first longitudinal linear section 1632 may be disposed to be covered with the first portion 1261 of the metal plate 126 in another embodiment. In a further embodiment, when viewed in the direction perpendicular to the first surface of the magnetic core, the outer border of the outermost line of the first longitudinal linear section 1632 may be disposed to substantially coincide with the first edge 1266. In a still further embodiment, when viewed in the direction perpendicular to the first surface of the magnetic core, an inner border of an innermost line of the first longitudinal linear section 1632 may be disposed to substantially coincide with the first edge 1266.

Meanwhile, in the illustrated embodiment, the lateral linear sections 1634, 1635, 1664 and 1665 are not covered with the metal plate. Alternatively, if the shape and dimension of the opening of the metal plate are changed, all the lateral linear sections may be covered with the metal plate.

### Further Embodiments

FIG. 3 shows that the antenna is disposed in an upper region of the smartphone. However, according to a further embodiment of the present disclosure, the antenna 35 may be disposed in a lower region of the smartphone 10 as shown in FIG. 13. Then, in response thereto, the opening of the metal plates 261 and 263 of the rear cover 22 and the electrically non-conductive cover 28 covering the opening may be also disposed at positions corresponding thereto. In some cases, it is apparent that the antenna may be disposed in a middle region.

In addition, although the side surface 60 and 160 of the magnetic core 52 and 152 is oriented to face the second portion 263 and 1263 wider than the first portion 261 and 1262 of the metal plate in FIGS. 3, 4 and 8, the present disclosure is not limited thereto. On the contrary, it is possible to orient the side surface 60 and 160 of the magnetic core 52 and 152 to face the narrower first portion 261 and 1261 of the metal plate.

In addition, although the opening of the metal plate is elongated generally parallel to a width direction W1 of the smartphone in FIGS. 3, 4 and 8, the present disclosure is not limited thereto. On the contrary, the opening may be elongated generally parallel to a length direction L1 of the smartphone.

In addition, although the opening of the metal plate is shown as a long rectangle in FIGS. 3, 4 and 8, the present disclosure is not limited thereto. Alternatively, the opening may have a shape approximate to a square. Furthermore, although the first edge and the second edge of the metal plate are parallel to each other in the illustrated embodiments, the present disclosure is not limited thereto. So far as radio waves having directionality can pass between the first edge and the second edge, the first edge and the second edge may not be parallel to each other, and the first edge and the second edge may be curved in other embodiments.

In the illustrated embodiments, the opening of the metal plate overlaps with at least a part of the near field communication antenna. On the other hand, the opening of the metal plate may overlap with a part of the battery or a part of another antenna (an antenna other than the near field communication antenna).

It will be understood by those skilled in the art that the expression meaning ‘two components overlap or do not overlap with or are superimposed on each other,’ the expression meaning ‘one component is covered or not covered with or is concealed by another component’ and the like are to express relative positions between the two components, when viewed in the direction perpendicular to the backside of the rear cover or the first surface of the magnetic core, unless other conditions are specially specified.

1. A smartphone comprising:
a housing; and
a near field communication (NFC) antenna housed in the housing,
wherein the housing comprises a rear cover defining a backside of the smartphone,
wherein the rear cover comprises:
an electrically conductive first metal plate portion,
an electrically conductive second metal plate portion spaced apart from the first metal plate portion, and
an electrically non-conductive cover portion disposed between the first metal plate portion and the second metal plate portion,
wherein the first metal plate portion comprises a first edge and the second metal plate portion comprises a second edge facing the first edge, and the electrically non-conductive cover portion connects the first edge and the second edge,
wherein the NFC antenna comprises:
a plate-shaped magnetic core, and
an antenna coil having a wire wound multiple times in a loop shape,
wherein the magnetic core comprises a first surface, a second surface facing opposite the first surface, and one side surface connecting the first surface and the second surface,
wherein the antenna coil comprises a first portion placed over the first surface of the magnetic core, a second portion placed over the second surface of the magnetic core, and a connection portion placed over the side surface of the magnetic core and connecting the first portion and the second portion, wherein the first portion, the second portion, and the connection portion are joined to form a loop, and
wherein the first portion comprises a first longitudinal linear section extending along a longitudinal direction parallel to the side surface of the magnetic core, wherein the first longitudinal linear section comprises a plurality of lines extending along the longitudinal direction and arranged parallel to one another, and at least part of the lines of the first longitudinal linear section do not overlap with the magnetic core when viewed in a direction perpendicular to the backside of the smartphone,
wherein the NFC antenna is disposed such that the first surface of the magnetic core faces the rear cover, and
wherein when viewed in the direction perpendicular to the backside of the smartphone, at least part of the lines of the first longitudinal linear section are disposed between the first edge and the second edge so that they do not overlap with the first metal plate portion or the second metal plate portion.

2. The smartphone of claim 1, wherein the second portion of the antenna coil comprises a second longitudinal linear section extending along the longitudinal direction parallel to the side surface of the magnetic core, the second longitudinal linear section comprises a plurality of lines extending along the longitudinal direction and arranged parallel to one another, and the second longitudinal linear section of the coil is spaced apart from the first longitudinal linear section such that there is no overlapping part when viewed in the direction perpendicular to the backside of the smartphone.

3. The smartphone of claim 2, wherein the magnetic core has another side surface facing opposite the one side surface, and the other side surface is disposed between the first longitudinal linear section and the second longitudinal linear section when viewed in the direction perpendicular to the backside of the smartphone.

4. The smartphone of claim 1, wherein the second portion of the antenna coil comprises a second longitudinal linear section extending along the longitudinal direction parallel to the side surface of the magnetic core, the second longitudinal linear section comprises a plurality of lines extending along the longitudinal direction and arranged parallel to one another, and three fourth or more of the lines of the second longitudinal linear section of the coil do not overlap with the lines of the first longitudinal linear section when viewed in the direction perpendicular to the backside of the smartphone.

5. The smartphone of claim 1, wherein the second portion of the antenna coil overlaps with the magnetic core when viewed in the direction perpendicular to the backside of the smartphone.

6. The smartphone of claim 5, further comprising an additional magnetic core placed over the second surface of the magnetic core, wherein the second portion of the antenna coil is disposed between the magnetic core and the additional magnetic core.

7. The smartphone of claim 1, wherein the side surface of the magnetic core is generally parallel to the second edge of the second metal plate portion, and the side surface is spaced apart from the second edge to be disposed between the first edge and the second edge when viewed in the direction perpendicular to the backside of the smartphone.

8. The smartphone of claim 1, wherein the magnetic core comprises another side surface facing opposite the one side surface, the other side surface is generally parallel to the first edge of the first metal plate portion, and when viewed in the direction perpendicular to the backside of the smartphone, the other side surface is disposed between the first edge and the second edge and a distance of the other side surface spaced apart from the first edge is larger than a distance of the one side surface spaced apart from the second edge.

9. A smartphone comprising:
a housing; and
a near field communication (NFC) antenna housed in the housing,
wherein the housing comprises a rear cover defining a backside of the smartphone,
wherein the rear cover comprises:
an electrically conductive first metal plate portion,
an electrically conductive second metal plate portion spaced apart from the first metal plate portion, and
an electrically non-conductive cover portion disposed between the first metal plate portion and the second metal plate portion,
wherein the first metal plate portion comprises a first edge and the second metal plate portion comprises a second edge facing the first edge, and the electrically non-conductive cover portion connects the first edge and the second edge,
wherein the NFC antenna comprises:
a plate-shaped magnetic core, and
an antenna coil having a wire wound multiple times in a loop shape,
wherein the magnetic core comprises a first surface, a second surface facing opposite the first surface, and one side surface connecting the first surface and the second surface, and
wherein the antenna coil comprises a first portion placed over the first surface of the magnetic core, a second portion placed over the second surface of the magnetic core, and a connection portion placed over the side surface of the magnetic core and connecting the first portion and the second portion, wherein the first portion, the second portion, and the connection portion are joined to form a loop,
wherein the NFC antenna is disposed such that the first surface of the magnetic core faces the rear cover, and
wherein when viewed in a direction perpendicular to the backside of the smartphone, at least a part of the first portion of the antenna coil is disposed between the first edge and the second edge so that radio waves generated by the first portion of the antenna coil may pass through the electrically non-conductive cover portion between the first edge and the second edge.

10. The smartphone of claim 9, wherein the first portion comprises a first longitudinal linear section extending along a longitudinal direction parallel to the side surface of the magnetic core, the first longitudinal linear section comprises a plurality of lines extending along the longitudinal direction and arranged parallel to one another, and for the lines of the first longitudinal linear section, at least a part of the first portion of the antenna coil is disposed between the first edge and the second edge so that it does not overlap with the first metal plate portion and the second metal plate portion when viewed in the direction perpendicular to the backside of the smartphone.

11. The smartphone of claim 10, wherein the first longitudinal linear section of the antenna coil does not overlap with the magnetic core when viewed in the direction perpendicular to the backside of the smartphone.

12. The smartphone of claim 10, wherein the second portion of the antenna coil comprises a second longitudinal linear section extending along the longitudinal direction parallel to the side surface of the magnetic core, the second longitudinal linear section comprises a plurality of lines extending along the longitudinal direction and arranged parallel to one another, and the second longitudinal linear section of the coil is spaced apart from the first longitudinal linear section of the coil such that there is no overlapping part when viewed in the direction perpendicular to the backside of the smartphone.

13. The smartphone of claim 12, wherein the magnetic core has another side surface facing opposite the one side surface, and the other side surface is disposed between the first longitudinal linear section and the second longitudinal linear section when viewed in the direction perpendicular to the backside of the smartphone.

14. The smartphone of claim 10, wherein the first longitudinal linear section of the antenna coil overlaps with the magnetic core when viewed in the direction perpendicular to the backside of the smartphone.

15. The smartphone of claim 10, wherein the second portion of the antenna coil comprises a second longitudinal linear section extending along the longitudinal direction parallel to the side surface of the magnetic core, the second longitudinal linear section comprises a plurality of lines extending along the longitudinal direction and arranged parallel to one another, and the first longitudinal linear section and the second longitudinal linear section of the coil overlap with each other when viewed in the direction perpendicular to the backside of the smartphone.

16. The smartphone of claim 9, wherein the second portion of the antenna coil overlaps with the magnetic core when viewed in the direction perpendicular to the backside of the smartphone.

17. The smartphone of claim 16, further comprising an additional magnetic core placed over the second surface of the magnetic core, wherein the second portion of the antenna coil is disposed between the magnetic core and the additional magnetic core.

18. The smartphone of claim 9, wherein the side surface of the magnetic core is generally parallel to the second edge of the second metal plate portion, and when viewed in the direction perpendicular to the backside of the smartphone, the side surface is disposed between the first edge and the second edge and spaced apart by a distance from the second edge so that part of magnetic flux passing through the side surface of the magnetic core may pass between the first edge and the second edge.

19. (canceled)

20. (canceled)

21. The smartphone of claim 14, wherein the magnetic core comprises another side surface facing opposite the one side surface, the other side surface is generally parallel to the first edge of the first metal plate portion, and when viewed in the direction perpendicular to the backside of the smartphone, the other side surface is disposed between the first edge and the second edge and a distance of the other side surface spaced apart from the first edge is smaller than a distance of the one side surface spaced apart from the second edge.

22. (canceled)

23. (canceled)

24. (canceled)

25. A method of performing near field communication with an NFC terminal device outside a smartphone provided with a near field communication (NFC) unit by using the smartphone, the method comprising:
providing the smartphone claim 9; and
supplying an electrical current signal to the antenna coil to generate radio waves to be transmitted to the NFC terminal device,
wherein a position where a magnetic field strength H generated by the supply of the electrical current signal has a maximum value among positions over the rear cover is between the first edge and the second edge.

26-31. (canceled)
